(19) United States
(12) Patent Application Publication
(10) Pub. No.: US 2024/0399510 A1
(43) Pub. Date: Dec. 5, 2024

(54) METHOD OF BAKING CHAMBER OF GAS LASER APPARATUS AND ELECTRONIC DEVICE MANUFACTURING METHOD

(71) Applicant: Gigaphoton Inc., Tochigi (JP)

(72) Inventor: Takahiro TATSUMI, Oyama-shi (JP)

(73) Assignee: Gigaphoton Inc., Tochigi (JP)

(21) Appl. No.: 18/799,424

(22) Filed: Aug. 9, 2024

Related U.S. Application Data
(63) Continuation of application No. PCT/JP2022/010366, filed on Mar. 9, 2022.

(51) Int. Cl. B23K 26/70; B23K 26/12; B23K 26/16; B23K 101/36

(52) U.S. Cl. CPC B23K 26/702; B23K 26/127; B23K 26/16; B23K 2101/36

(57) ABSTRACT

A method of baking a chamber of a gas laser apparatus provided with a cooling passage configured to make a cooling medium that cools the chamber flow on an outer side of a wall surface in contact with an internal space of the chamber for generating light in the internal space includes a heating step of heating the internal space via the wall surface by making a heating medium flow through the cooling passage before generating the light in the internal space, and an exhaust step of exhausting a gas in the heated internal space to an external space of the chamber.

### CROSS-REFERENCE TO RELATED APPLICATIONS

The present application is a continuation application of International Application No. PCT/JP2022/010366, filed on Mar. 9, 2022, the entire contents of which are hereby incorporated by reference.

### BACKGROUND

### 1. Technical Field

The present disclosure relates to a method of baking a chamber of a gas laser apparatus and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser apparatus for exposure, a KrF excimer laser apparatus that outputs a laser beam having a wavelength of about 248 nm and an ArF excimer laser apparatus that outputs a laser beam having a wavelength of about 193 nm are used.

Spectral linewidths of spontaneous oscillation beams of the KrF excimer laser apparatus and the ArF excimer laser apparatus are as wide as from 350 μm to 400 pm. Therefore, when a projection lens is formed of a material that transmits ultraviolet light such as a KrF laser beam and an ArF laser beam, chromatic aberration may occur. As a result, the resolution may decrease. Given this, the spectral linewidth of the laser beam output from the gas laser apparatus needs to be narrowed to an extent that the chromatic aberration is ignorable. Therefore, in a laser resonator of the gas laser apparatus, a line narrowing module (LNM) including a line narrowing element (etalon or grating, etc.) may be provided in order to narrow the spectral linewidth. Hereinafter, a gas laser apparatus with a narrowed spectral linewidth is referred to as a line narrowing gas laser apparatus.

### LIST OF DOCUMENTS

### Patent Documents

Patent Document 1: Japanese Unexamined Patent Application Publication No. 2001-313432

### SUMMARY

A method of baking a chamber of a gas laser apparatus according to an aspect of the present disclosure is a method of baking a chamber of a gas laser apparatus provided with a cooling passage configured to make a cooling medium that cools the chamber flow on an outer side of a wall surface in contact with an internal space of the chamber for generating light in the internal space, and the method may include a heating step of heating the internal space via the wall surface by making a heating medium flow through the cooling passage before generating the light in the internal space, and an exhaust step of exhausting a gas in the heated internal space to an external space of the chamber.

An electronic device manufacturing method according to an aspect of the present disclosure may include generating a laser beam by a gas laser apparatus including a chamber baked by a method of baking a chamber of a gas laser apparatus provided with a cooling passage configured to make a cooling medium that cools the chamber flow on an outer side of a wall surface in contact with an internal space of the chamber for generating light in the internal space, outputting the laser beam to an exposure apparatus, and exposing a photosensitive substrate to the laser beam within the exposure apparatus to manufacture an electronic device. The baking method includes a heating step of heating the internal space via the wall surface by making a heating medium flow through the cooling passage before generating the light in the internal space, and an exhaust step of exhausting a gas in the heated internal space to an external space of the chamber.

### BRIEF DESCRIPTION OF THE DRAWINGS

Some embodiments of the present disclosure will be described below, by way of example only, with reference to the accompanying drawings.

FIG. 1 is a schematic diagram illustrating a schematic configuration example of an entire electronic device manufacturing apparatus.

FIG. 2 is a schematic diagram illustrating a schematic configuration example of an entire gas laser apparatus of a comparative example.

FIG. 3 is a sectional view perpendicular to a laser beam traveling direction in a chamber of the comparative example.

FIG. 4 is a diagram illustrating an example of a flowchart of a method of baking a chamber of the comparative example.

FIG. 5 is a diagram illustrating a disposition of a chamber at the time of baking in the comparative example.

FIG. 6 is a perspective view of a chamber of an embodiment.

FIG. 7 is a sectional view perpendicular to a laser beam traveling direction of a chamber of the embodiment.

FIG. 8 is a perspective view of an outer body part of an outer housing surrounding an inner housing and a partition wall.

FIG. 9 is a diagram illustrating a positional relationship between a fin and a partition wall.

FIG. 10 is a diagram illustrating a disposition of a chamber at the time of baking in the embodiment.

FIG. 11 is a diagram illustrating an example of a flowchart of a baking method in the embodiment.

FIG. 12 is a sectional view of a chamber in a modification.

### DESCRIPTION OF EMBODIMENTS

1. Description of Electronic Device Manufacturing Apparatus Used in Exposure Process of Electronic Device

2. Description of Gas Laser Apparatus of Comparative Example
2.1 Configuration
2.2 Operation
2.3 Method of Baking Chamber
2.4 Problem

3. Description of Chamber of Embodiment
3.1 Configuration
3.2 Method of Baking Chamber
3.3 Effect

Hereinafter, embodiments of the present disclosure will be described in detail with reference to the drawings.

The embodiments described below show some examples of the present disclosure and do not limit contents of the present disclosure. In addition, all configurations and operations described in the embodiments are not necessarily essential as configurations and operations of the present disclosure. Here, the same components are denoted by the same reference numerals, and any redundant description thereof is omitted.

### 1. Description of Electronic Device Manufacturing Apparatus Used in Exposure Process of Electronic Device

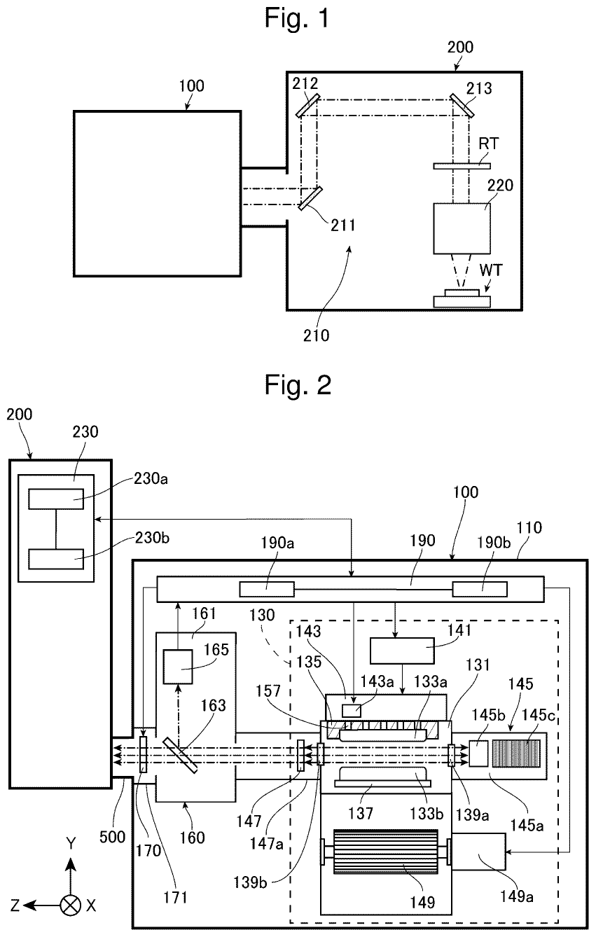

FIG. 1 is a schematic diagram illustrating a schematic configuration example of an entire electronic device manufacturing apparatus used in an exposure process of an electronic device. As illustrated in FIG. 1, the manufacturing apparatus used in the exposure process includes a gas laser apparatus 100 and an exposure apparatus 200. The exposure apparatus 200 includes an illumination optical system 210 including a plurality of mirrors 211, 212, and 213, and a projection optical system 220. The illumination optical system 210 illuminates a reticle pattern of a reticle stage RT by a laser beam entering from the gas laser apparatus 100. The projection optical system 220 performs reduction projection of the laser beam transmitted through a reticle and forms an image on an unillustrated workpiece disposed on a workpiece table WT. The workpiece is a photosensitive substrate such as a semiconductor wafer on which photoresist is applied. The exposure apparatus 200 synchronously translates the reticle stage RT and the workpiece table WT to expose the workpiece to a laser beam reflecting the reticle pattern. Through the exposure process as described above, a semiconductor device which is an electronic device can be manufactured by transferring a device pattern onto the semiconductor wafer.

### 2. Description of Gas Laser Apparatus of Comparative Example

### 2.1 Configuration

The gas laser apparatus 100 of a comparative example will be described. Note that the comparative example of the present disclosure is an example recognized by the applicant as known only by the applicant, and is not a publicly known example admitted by the applicant.

FIG. 2 is a schematic diagram illustrating a schematic configuration example of the entire gas laser apparatus 100 of the comparative example. The gas laser apparatus 100 is, for example, an ArF excimer laser apparatus using a mixed gas containing argon (Ar), fluorine (F₂), and neon (Ne). The gas laser apparatus 100 outputs a laser beam having a center wavelength of about 193 nm. Note that the gas laser apparatus 100 may be a gas laser apparatus other than the ArF excimer laser apparatus, and may be, for example, a KrF excimer laser apparatus using a mixed gas containing krypton (Kr), F₂, and Ne. In this case, the gas laser apparatus 100 outputs a laser beam having a center wavelength of about 248 nm. The mixed gas containing Ar, F₂, and Ne, which are the laser media, and the mixed gas containing Kr, F₂, and Ne, which are the laser media, may be referred to as a laser gas.

The gas laser apparatus 100 mainly includes a housing 110, and a laser oscillator 130, a monitor module 160, a shutter 170, and a laser processor 190 that are disposed in an internal space of the housing 110.

The laser oscillator 130 includes a chamber 131, a charger 141, a pulse power module 143, a line narrowing module 145, and an output coupling mirror 147. FIG. 2 illustrates an internal configuration of the chamber 131 viewed from a direction substantially perpendicular to a laser beam traveling direction.

Examples of a material of the chamber 131 include, for example, metals such as nickel plated aluminum and nickel plated stainless steel. The chamber 131 includes an internal space in which light is generated by excitation of a laser medium in the laser gas. The light travels to windows 139a and 139b to be described later. The laser gas is supplied from an unillustrated laser gas supply source to the internal space of the chamber 131 through an unillustrated pipe. Further, the laser gas in the chamber 131 is subjected to processing of removing F₂ gas by a halogen filter or the like, and is exhausted to the housing 110 through an unillustrated pipe by an unillustrated exhaust pump.

In the internal space of the chamber 131, an electrode 133a and an electrode 133b are spaced apart from each other and are disposed to face each other, and a longitudinal direction of each is along the laser beam traveling direction. Hereinafter, the longitudinal direction of the electrodes 133a and 133b may be described as a Z direction, a direction which is orthogonal to the Z direction and in which the electrodes 133a and 133b are arranged and separated from each other may be described as a Y direction, and a direction orthogonal to the Y direction and the Z direction may be described as an X direction. The electrodes 133a and 133b are discharge electrodes for exciting the laser medium by glow discharge. In the present example, the electrode 133a is a cathode and the electrode 133b is an anode.

The electrode 133a is fixed to a surface on a side of the internal space of the chamber 131 of a planar electric insulating part 135 by a conductive member 157 which is, for example, a bolt. The conductive member 157 is electrically connected to the pulse power module 143, and applies a high voltage from the pulse power module 143 to the electrode 133a. The electrode 133b is supported by and electrically connected to an electrode holder part 137.

The electric insulating part 135 includes an insulator. Examples of a material of the electric insulating part 135 include, for example, alumina ceramics having poor reactivity with the F₂ gas. The electric insulating part 135 may be electrically insulating, and examples of the material of such an electric insulating part 135 include a resin such as a phenol resin and a fluororesin, quartz, and glass. The electric insulating part 135 closes an opening provided in the chamber 131 and is fixed to the chamber 131.

The charger 141 is a DC power supply device that charges an unillustrated charging capacitor in the pulse power module 143 with a predetermined voltage. The pulse power module 143 includes a switch 143a controlled by the laser processor 190. When the switch 143a is switched from OFF to ON, the pulse power module 143 generates a pulsed high voltage from electric energy held in the charger 141 and applies the high voltage between the electrode 133a and the electrode 133b.

When the high voltage is applied between the electrode 133a and the electrode 133b, discharge occurs between the electrode 133a and the electrode 133b. Energy of the discharge excites the laser medium in the chamber 131, and the excited laser medium outputs light when shifting to a ground state.

The chamber 131 is provided with a pair of windows 139a and 139b. The window 139a is located on one end side in the laser beam traveling direction in the chamber 131, the window 139b is located on the other end side in the traveling direction, and the windows 139a and 139b sandwich a space between the electrode 133a and the electrode 133b. The windows 139a and 139b are inclined to form a Brewster's angle with respect to the laser beam traveling direction so as to suppress reflection of P-polarized light of the laser beam. The laser beam oscillated as described later is output to an outside of the chamber 131 through the windows 139a and 139b. Since the pulse high voltage is applied between the electrode 133a and the electrode 133b by the pulse power module 143 as described above, the laser beam is a pulse laser beam.

The line narrowing module 145 includes a housing 145a, and a prism 145b, a grating 145c and an unillustrated rotating stage disposed in an internal space of the housing 145a. An opening is formed in the housing 145a, and the housing 145a is connected to a rear side of the chamber 131 via the opening.

The prism 145b expands a beam width of the light output from the window 139a and makes the light enter the grating 145c. The prism 145b also reduces a beam width of reflected light from the grating 145c and returns the light to the internal space of the chamber 131 via the window 139a. The prism 145b is supported by the rotating stage and is rotated by the rotating stage. Rotation of the prism 145b changes an incident angle of the light on the grating 145c. Thus, by the rotation of the prism 145b, a wavelength of the light returning from the grating 145c to the chamber 131 via the prism 145b can be selected. While FIG. 2 illustrates an example in which one prism 145b is disposed, at least one prism may be disposed.

A surface of the grating 145c is made of a material having a high reflectance, and many grooves are provided on the surface at predetermined intervals. A cross-sectional shape of each groove is, for example, a right-angled triangle. The light entering the grating 145c from the prism 145b is reflected by the grooves and diffracted in a direction corresponding to the wavelength of the light. The grating 145c is disposed in Littrow arrangement so that the incident angle of the light entering the grating 145c from the prism 145b coincides with a diffracting angle of diffracted light having a desired wavelength. Thus, light near the desired wavelength is returned to the chamber 131 through the prism 145b.

The output coupling mirror 147 is disposed in an internal space of an optical path pipe 147a connected to a front side of the chamber 131 and faces the window 139b. The output coupling mirror 147 transmits a part of the laser beam output from the window 139b toward the monitor module 160, and reflects the other part to return the laser beam to the internal space of the chamber 131 through the window 139b. Thus, the grating 145c and the output coupling mirror 147 configure a Fabry-Perot laser resonator, and the chamber 131 is disposed on an optical path of the laser resonator.

The monitor module 160 is disposed on an optical path of the laser beam output from the output coupling mirror 147. The monitor module 160 includes a housing 161, and a beam splitter 163 and a photosensor 165 disposed in an internal space of the housing 161. An opening is formed in the housing 161, and the internal space of the housing 161 communicates with the internal space of the optical path pipe 147a via the opening.

The beam splitter 163 transmits a part of the laser beam output from the output coupling mirror 147 toward the shutter 170, and reflects the other part of the laser beam toward a light receiving surface of the photosensor 165. The photosensor 165 measures energy E of the laser beam which has entered the light receiving surface. The photosensor 165 outputs a signal indicating the measured energy E to the laser processor 190.

The laser processor 190 of the present disclosure is a processor including a storage device 190a in which a control program is stored and a CPU (Central Processing Unit) 190b that executes the control program. The laser processor 190 is specially configured or programmed to execute various kinds of processing included in the present disclosure. In addition, the laser processor 190 controls the entire gas laser apparatus 100.

The laser processor 190 transmits and receives various kinds of signals to and from an exposure processor 230 of the exposure apparatus 200. For example, the laser processor 190 receives, from the exposure processor 230, signals indicating a light emission trigger Tr to be described later and target energy Et or the like. The target energy Et is a target value of energy of the laser beam used in the exposure process. The laser processor 190 controls a charging voltage of the charger 141 based on the energy E and the target energy Et received from the photosensor 165 and the exposure processor 230. By controlling the charging voltage, the energy of the laser beam is controlled. In addition, the laser processor 190 transmits a command signal for ON or OFF of the switch 143a to the pulse power module 143. Further, the laser processor 190 is electrically connected to the shutter 170 and controls opening and closing of the shutter 170.

The laser processor 190 closes the shutter 170 until a difference ΔE between the energy E received from the monitor module 160 and the target energy Et received from the exposure processor 230 falls within an allowable range. When the difference ΔE is within the allowable range, the laser processor 190 transmits a reception ready signal which reports that the light emission trigger Tr is ready to be received to the exposure processor 230. The exposure processor 230 transmits a signal indicating the light emission trigger Tr to the laser processor 190 upon receiving the reception ready signal, and the laser processor 190 opens the shutter 170 upon receiving the signal indicating the light emission trigger Tr. The light emission trigger Tr is defined by a predetermined repetition frequency f and a predetermined pulse count P of the laser beam, is a timing signal for causing the exposure processor 230 to laser-oscillate the laser oscillator 130, and is an external trigger. The repetition frequency f of the laser beam is, for example, equal to or higher than 100 Hz and equal to or lower than 10 kHz.

The shutter 170 is disposed on an optical path of a laser beam that has passed through an opening formed on a side opposite to a side to which the optical path pipe 147a is connected in the housing 161 of the monitor module 160. Further, the shutter 170 is disposed in an internal space of an optical path pipe 171. The optical path pipe 171 is connected to the housing 161 so as to surround the opening, and communicates with the housing 161. In the internal spaces of the optical path pipes 171 and 147a and the internal spaces of the housings 161 and 145a, a purge gas is supplied and filled. The purge gas includes an inert gas such as nitrogen (N₂). The purge gas is supplied from an unillustrated purge gas supply source through an unillustrated pipe. The optical path pipe 171 communicates with the exposure apparatus 200 through an opening of the housing 110 and an optical path pipe 500 connecting the housing 110 and the exposure apparatus 200. The laser beam that has passed through the shutter 170 enters the exposure apparatus 200.

The exposure processor 230 of the present disclosure is a processor including a storage device 230a in which a control program is stored, and a CPU 230b that executes the control program. The exposure processor 230 is specially configured or programmed to execute various kinds of processing included in the present disclosure. In addition, the exposure processor 230 controls the entire exposure apparatus 200.

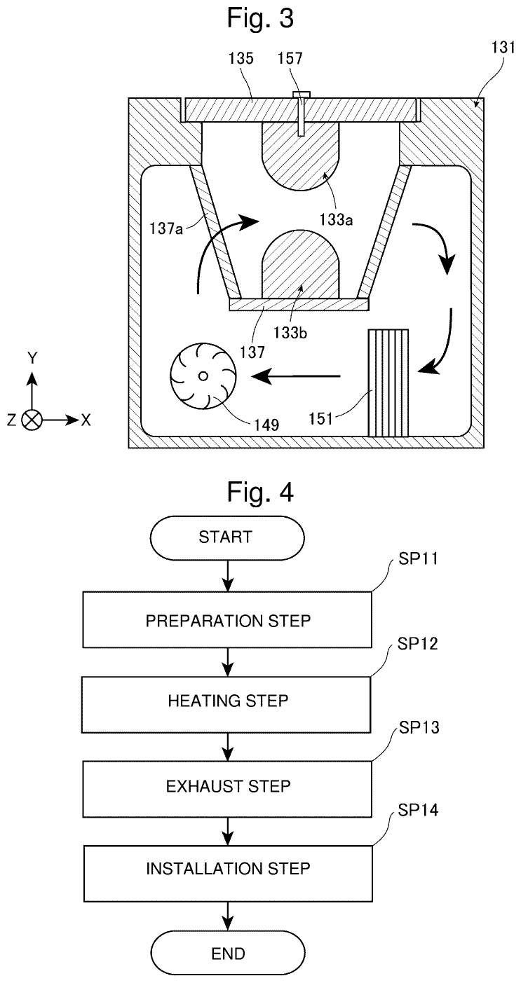

FIG. 3 is a sectional view perpendicular to the laser beam traveling direction in the chamber 131 of the comparative example. In the internal space of the chamber 131, a cross flow fan 149 and a heat exchanger 151 are further disposed.

The cross flow fan 149 and the heat exchanger 151 are disposed in the internal space of the chamber 131 on the side opposite to a side of the electrode 133b with respect to the electrode holder part 137. In the internal space of the chamber 131, a space where the cross flow fan 149 and the heat exchanger 151 are disposed communicates with a space between the electrode 133a and the electrode 133b. The heat exchanger 151 is disposed beside the cross flow fan 149, and is connected to an unillustrated pipe through which a cooling medium, which is a liquid or a gas, flows. The heat exchanger 151 is a radiator. As illustrated in FIG. 2, the cross flow fan 149 is connected to a motor 149a disposed outside the chamber 131, and is rotated by rotation of the motor 149a. As the cross flow fan 149 is rotated, the laser gas enclosed in the internal space of the chamber 131 is circulated as indicated by bold arrows in FIG. 3. That is, the laser gas is circulated in an order of the cross flow fan 149, the space between the electrode 133a and the electrode 133b, the heat exchanger 151, and the cross flow fan 149. At least a part of the circulated laser gas passes through the heat exchanger 151, and a temperature of the laser gas is adjusted by the heat exchanger 151. ON and OFF and a rotational speed of the motor 149a are controlled by the laser processor 190. Accordingly, the laser processor 190 can adjust a circulation speed of the laser gas circulated in the internal space of the chamber 131 by controlling the motor 149a.

The electrode holder part 137 is electrically connected to the chamber 131 via a wire 137a. The electrode 133b supported by the electrode holder part 137 is connected to a ground potential via the electrode holder part 137, the wire 137a, and the chamber 131.

On the electrode holder part 137, an unillustrated preionization electrode is provided on the lateral side of the electrode 133b. The preionization electrode includes an inner electrode, an outer electrode, and a dielectric. The inner electrode is connected to the pulse power module 143 via an unillustrated wire. The outer electrode is electrically connected to the electrode 133b via the electrode holder part 137, and is electrically connected to the chamber 131 via the electrode holder part 137 and the wire 137a. Therefore, the outer electrode is connected to the ground potential via the electrode holder part 137, the wire 137a, and the chamber 131. The dielectric is a pipe having a cylindrical shape, and a longitudinal direction is disposed along the laser beam traveling direction. Inside the dielectric, the inner electrode the longitudinal direction of which is along the longitudinal direction of the dielectric is disposed. The dielectric is formed of, for example, aluminum oxide, and is disposed between the inner electrode and the outer electrode. When a high voltage is applied from the pulse power module 143 to the inner electrode and the outer electrode, corona discharge occurs near the dielectric and the outer electrode. This corona discharge assists in stable generation of glow discharge which occurs between the electrodes 133a and 133b.

### 2.2 Operation

Next, the operation of the gas laser apparatus 100 of the comparative example will be described.

Before the gas laser apparatus 100 outputs a laser beam, the internal spaces of the optical path pipes 147a, 171, and 500 and the internal spaces of the housings 145a and 161 are filled with the purge gas from the unillustrated purge gas supply source. In addition, the laser gas is supplied to the internal space of the chamber 131 from an unillustrated laser gas supply source. When the laser gas is supplied, the laser processor 190 controls the motor 149a to rotate the cross flow fan 149. The rotation of the cross flow fan 149 causes the laser gas to be circulated in the internal space of the chamber 131.

When the gas laser apparatus 100 outputs a laser beam, the laser processor 190 receives a signal indicating the target energy Et and a signal indicating the light emission trigger Tr from the exposure processor 230. Upon receiving the signal indicating the target energy Et, the laser processor 190 closes the shutter 170 to drive the charger 141. The laser processor 190 also turns ON the switch 143a of the pulse power module 143. Thus, the pulse power module 143 applies a pulsed high voltage between the electrode 133a and the electrode 133b and between the inner electrode and the outer electrode from the electric energy held in the charger 141. However, timing at which the high voltage is applied between the inner electrode and the outer electrode is slightly earlier than timing at which the high voltage is applied between the electrode 133a and the electrode 133b. When the high voltage is applied between the inner electrode and the outer electrode, the corona discharge occurs near the dielectric, and ultraviolet light is radiated. When the laser gas between the electrode 133a and the electrode 133b is irradiated with the ultraviolet light, the laser gas between the electrode 133a and the electrode 133b is preionized. After preionization, when the high voltage is applied between the electrode 133a and the electrode 133b, the discharge occurs between the electrode 133a and the electrode 133b. Thus, the laser medium contained in the laser gas between the electrode 133a and the electrode 133b is turned to an excited state, and light is output when the laser medium returns to the ground state. By this light, the light resonates between the grating 145c and the output coupling mirror 147, the light is amplified every time of passing through a discharge space in the internal space of the chamber 131, and laser oscillation occurs. A part of the laser beam is transmitted through the output coupling mirror 147 as a pulse laser beam and travels to the beam splitter 163.

A part of the laser beam which has traveled to the beam splitter 163 is reflected by the beam splitter 163 and is received by the photosensor 165. The photosensor 165 measures the energy E of the received laser beam, and outputs the signal indicating the energy E to the laser processor 190. The laser processor 190 controls the charging voltage so that the difference ΔE between the energy E and the target energy Et falls within the allowable range, and after the difference ΔE falls within the allowable range, transmits the reception ready signal indicating that the light emission trigger Tr is ready to be received to the exposure processor 230.

Upon receiving the reception ready signal, the exposure processor 230 transmits the light emission trigger Tr to the laser processor 190. When the laser processor 190 opens the shutter 170 in synchronization with reception of the light emission trigger Tr, the laser beam that has passed through the shutter 170 enters the exposure apparatus 200. The laser beam is a pulse laser beam having a center wavelength of 193 nm for example.

By circulation of the laser gas, gas impurities generated by the discharge between the electrode 133a and the electrode 133b move downstream, and a fresh laser gas is supplied between the electrode 133a and the electrode 133b for the subsequent discharge. Further, when the laser gas passes through the heat exchanger 151, heat caused by the discharge is removed, and a temperature rise of the laser gas is suppressed.

### 2.3 Method of Baking Chamber

In the operation described above, a case where moisture is adsorbed in internal components of the chamber 131 such as the electrode 133a disposed in the internal space of the chamber 131 when light from the laser gas in the internal space of the chamber 131 is output from the chamber 131 will be described. For example, the moisture is adsorbed by cleaning the chamber 131 before the chamber 131 is installed in the gas laser apparatus 100. When the moisture reacts with the laser gas in the internal space of the chamber 131, gas impurities may be generated. The gas impurities may absorb the laser beam in the chamber 131 to reduce output of the laser beam, or may deteriorate the discharge between the electrode 133a and the electrode 133b, thereby hindering the output of the laser beam satisfying performance demanded by the exposure apparatus 200. Therefore, before generating light in the internal space of the chamber 131, it is necessary to bake the internal space of the chamber 131 to remove the adsorbed moisture. That is, a baking process is a part of a preparation process of the gas laser apparatus 100, and is performed before the gas laser apparatus 100 is actually operated, that is, before generating light in the internal space of the chamber 131.

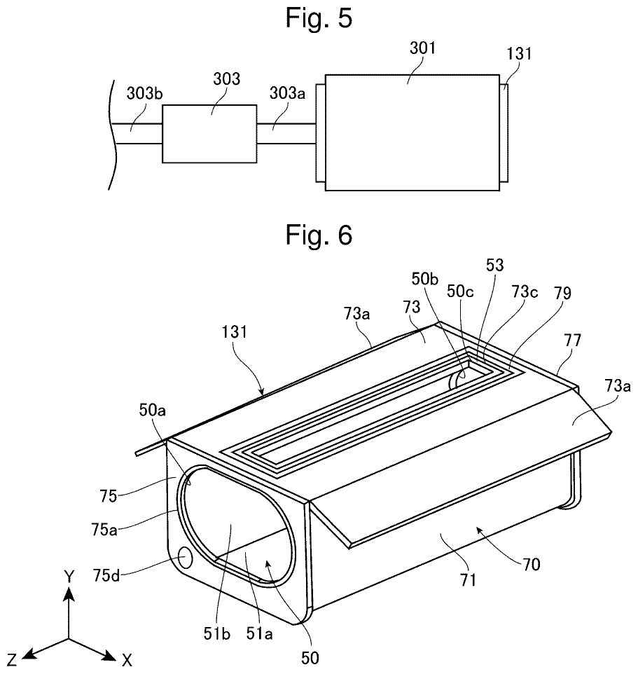

FIG. 4 is a diagram illustrating an example of a flowchart of a method of baking the chamber 131 of the gas laser apparatus 100 of the comparative example. Hereinafter, the method of baking the chamber 131 may be simply referred to as a baking method. The baking method of the comparative example includes a preparation step SP11, a heating step SP12, an exhaust step SP13, and an installation step SP14. FIG. 5 is a diagram illustrating a disposition of the chamber 131 at the time of baking in the comparative example. The baking method of the comparative example is performed before the chamber 131 is installed in the housing 110 of the gas laser apparatus 100. Accordingly, the chamber 131 is baked outside the housing 110.

### (Preparation Step SP11)

In this step, the chamber 131 is installed in an unillustrated facility for baking, that is located outside the housing 110, and a mantle heater 301 is wound around an outer side of the chamber 131 outside the housing 110. In FIG. 5, the chamber 131 is simply illustrated. In addition, in this step, one pipe 303a to which a vacuum pump 303 is connected is attached to the chamber 131. The pipe 303a passes through the chamber 131 and communicates with the internal space of the chamber 131. The other pipe 303b is connected to the vacuum pump 303, and the pipe 303b communicates with the outside. Once such preparation is complete, a flow proceeds to the heating step SP12.

### (Heating Step SP12)

In this step, the mantle heater 301 is heated to 150° C. or higher to heat the internal space of the chamber 131. By heating, the moisture adsorbed in the internal components of the chamber 131 is desorbed from the internal components. Then, the flow proceeds to the exhaust step SP13.

### (Exhaust Step SP13)

In this step, the gas impurities including the moisture desorbed from the internal space of the heated chamber 131 are sucked by the vacuum pump 303 through the pipe 303a, and the sucked gas is exhausted to an external space of the chamber 131 through the pipe 303b. In this way, the gas impurities including the desorbed moisture are exhausted from the internal space of the heated chamber 131 to the external space of the chamber 131 by the vacuum pump 303. Then, the flow proceeds to the installation step SP14.

### (Installation Step SP14)

In this step, the chamber 131 is installed in the housing 110 of the gas laser apparatus 100, and the flow ends. Then, the gas laser apparatus 100 stands by for an actual operation.

### 2.4 Problem

In the baking method of the comparative example, while the mantle heater 301 is wound around the outer side of the chamber 131, a gap may be formed between the chamber 131 and the mantle heater 301. This gap makes heat of the mantle heater 301 less likely to be transferred to the chamber 131, it may take time to heat the internal space of the chamber 131 and it may take time to bake the chamber 131. Therefore, it is required to shorten a baking period.

Therefore, the following embodiment illustrates a method of baking the chamber 131 of the gas laser apparatus 100 that can shorten the baking period.

### 3. Description of Chamber of Embodiment

Next, the chamber 131 of the embodiment will be described. Any configuration same as that described above is denoted by an identical sign, and redundant description is omitted unless specific description is needed. In addition, in some drawings, a part of a member may be omitted or simplified for the sake of clarity.

### 3.1 Configuration

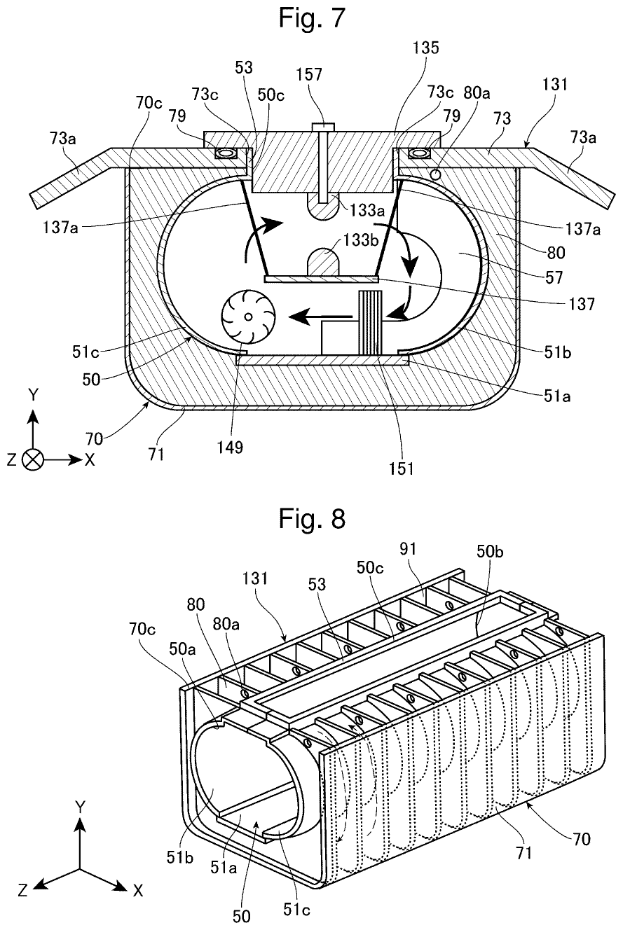

FIG. 6 is a perspective view of the chamber 131 of the present embodiment. FIG. 7 is a sectional view perpendicular to the laser beam traveling direction of the chamber 131 of the present embodiment. In FIG. 7, as in the comparative example illustrated in FIG. 3, the flow of the laser gas is indicated by bold arrows.

In the chamber 131 of the present embodiment, the configuration of the chamber 131 is different from the configuration of the chamber 131 of the comparative example. The chamber 131 of the present embodiment mainly includes a cylindrical inner housing 50, an outer housing 70 that surrounds the inner housing 50 from the outside, and a partition wall 80 disposed between the inner housing 50 and the outer housing 70 on a lateral side of the laser beam traveling direction.

Similarly to the chamber 131 of the comparative example, the inner housing 50 includes an internal space in which light is generated from the laser gas and a wall surface in contact with the internal space. In the internal space, similarly to the internal space of the chamber 131 of the comparative example, the electrodes 133a and 133b, the electric insulating part 135, the electrode holder part 137, the cross flow fan 149, the heat exchanger 151, and the preionization electrode are disposed. The respective pipes of the laser gas supply source and the exhaust pump pass through the outer housing 70 and communicate with the internal space of the inner housing 50. The longitudinal direction of the inner housing 50 is along the laser beam traveling direction in the internal space of the inner housing 50, and the laser beam passes through openings 50a and 50b which are passage openings at both ends of the cylindrical inner housing 50 in the longitudinal direction. Such an inner housing 50 surrounds a periphery of the laser beam traveling through the internal space of the inner housing 50.

FIG. 8 is a perspective view of an outer body part 71 of the outer housing 70 surrounding the inner housing 50 and the partition wall 80. In FIG. 8, a portion of the inner housing 50 and the partition wall 80 surrounded by the outer body part 71 is indicated by broken lines.

As illustrated in FIG. 7 and FIG. 8, the inner housing 50 mainly includes a rectangular bottom plate 51a long in the longitudinal direction of the inner housing 50 and a pair of curved plates 51b and 51c in a semicircular tubular shape. The curved plates 51b and 51c each have the same size. When viewing the bottom plate 51a and the curved plates 51b and 51c along the longitudinal direction of the inner housing 50, the curved plates 51b and 51c are disposed bisymmetrically with respect to the bottom plate 51a, and are curved so as to bulge in a direction away from each other. In a width direction of the bottom plate 51a orthogonal to the longitudinal direction of the inner housing 50, that is, in the X direction, an outer peripheral surface at one end of the curved plate 51b is fixed to an inner surface at one end of the bottom plate 51a, and an outer peripheral surface at one end of the curved plate 51c is fixed to an inner surface at the other end of the bottom plate 51a by brazing. The curved plates 51b and 51c are brazed over an entire contacting portion with the bottom plate 51a. As a result, leakage of the laser gas from the fixed portion to the outside of the inner housing 50 is suppressed. Further, a part of the other ends of the curved plates 51b and 51c is bent toward the outer side of the inner housing 50 in a direction substantially perpendicular to the bottom plate 51a. Each of the other bent ends is fixed by brazing as described above, and a frame-shaped protrusion 53 is provided. The frame-shaped protrusion 53 has a rectangular shape that is long in the longitudinal direction of the inner housing 50, and an opening 50c is provided on an inner side of the frame-shaped protrusion 53. The opening 50c has a rectangular shape that is long in the longitudinal direction of the inner housing 50, and is closed by the electric insulating part 135. On the outer side of the protrusion 53 in the longitudinal direction of the inner housing 50, the remaining part of the other ends of the curved plates 51b and 51c is bent so as to face the bottom plate 51a, and is fixed to each other by brazing. A surface of the bottom plate 51a and the curved plates 51b and 51c configured in such a manner that is in contact with the internal space of the inner housing 50 can be understood as a wall surface of the inner housing 50 that is in contact with the internal space of the inner housing 50.

A plate thickness of the bottom plate 51a is greater than a plate thickness of the curved plates 51b and 51c which are plates other than the bottom plate 51a in the inner housing 50. For example, the plate thickness of the bottom plate 51a is equal to or more than 5 mm and equal to or less than 7 mm, and the plate thickness of the curved plates 51b and 51c is equal to or more than 1 mm and equal to or less than 3 mm. When the bottom plate 51a which is a flat plate is thicker than the curved plates 51b and 51c, strength of the bottom plate 51a increases as compared to a case where the bottom plate 51a has the same thickness as the curved plates 51b and 51c. Further, when the bottom plate 51a is a flat plate, volume of the chamber 131 is reduced as compared to a case where the bottom plate 51a is a curved plate curved so as to bulge in a direction of separating from a central axis of the inner housing 50. When the volume is reduced, a consumption amount of the laser gas from the laser gas supply source is reduced, and the entire gas laser apparatus 100 is reduced in size. Examples of a material of the inner housing 50 include stainless steel and aluminum. For example, SUS316L is preferable as the stainless steel.

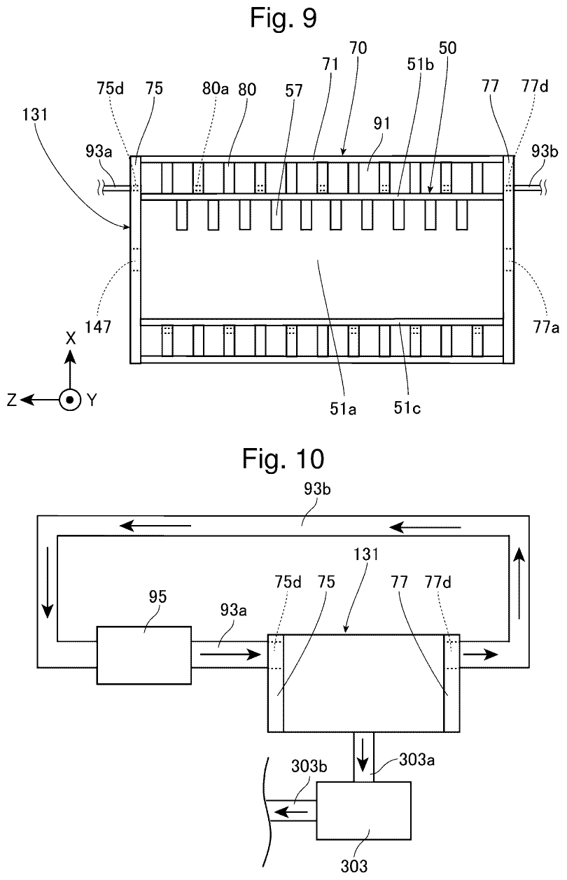

As illustrated in FIG. 7, a fin 57 is fixed to a part of an inner peripheral surface of the inner housing 50 by brazing. The fin 57 is brazed over an entire contacting portion with the inner peripheral surface of the inner housing 50. FIG. 7 illustrates an example in which the fin 57 is fixed to a surface of the bottom plate 51a and to an inner peripheral surface of the curved plate 51c. The fin 57 is disposed downstream of the space between the electrode 133a and the electrode 133b in a traveling direction of the laser gas that is circulated in the internal space of the inner housing 50 by the cross flow fan 149. The fin 57 is disposed beside a traveling route of a laser beam in the internal space of the inner housing 50, and does not hinder traveling of the laser beam. Heat from a heating medium to be described later is discharged to the internal space of the inner housing 50 via the fin 57. Illustration of the fin 57 is omitted in the drawings other than FIG. 7 and FIG. 9 to be described later. A surface of the fin 57 that is in contact with the internal space of the inner housing 50 can be understood as a wall surface of the inner housing 50 that is in contact with the internal space of the inner housing 50.

As illustrated in FIG. 6, FIG. 7, and FIG. 8, the outer housing 70 surrounds the inner housing 50 from the lateral side, front side, and rear side of the laser beam traveling direction. Such an outer housing 70 mainly includes the outer body part 71, a lid plate 73, a front plate 75, and a rear plate 77.

The outer body part 71 is a plate that laterally surrounds the inner housing 50 and includes an opening 70c on the lateral side. A cross section of such an outer body part 71 has, for example, a U-shape, and the outer body part 71 is disposed to face the bottom plate 51a, the curved plates 51b and 51c, and the side faces of the protrusion 53 of the inner housing 50, respectively. The outer body part 71 has a substantially same length as the inner housing 50, and a longitudinal direction of the outer body part 71 is along the longitudinal direction of the inner housing 50.

The lid plate 73 is disposed at both ends of the outer body part 71 and the opening 70c at both ends, and covers the side of the opening 70c of the outer body part 71. The lid plate 73 is provided with an opening 73c into which the protrusion 53 of the inner housing 50 is fitted. Further, a groove is provided on an upper surface of the lid plate 73. The groove is provided around the opening 73c and has a rectangular shape long in the longitudinal direction of the inner housing 50. A sealing member 79 for sealing between the lid plate 73 and the electric insulating part 135 is disposed in the groove. The sealing member 79 is, for example, a metal seal.

Further, the lid plate 73 includes a protruding part 73a protruding outward from a side face of the outer body part 71 in the X direction orthogonal to the longitudinal direction of the outer body part 71. The side face is a surface of the outer body part 71 facing the curved plates 51b and 51c in a width direction of the bottom plate 51a of the inner housing 50. The protruding part 73a is provided on each of both end sides of the lid plate 73 in the X direction orthogonal to the longitudinal direction. Each protruding part 73a is bent toward the side face of the outer body part 71 with respect to the lid plate 73 so as to surround the side face. When the protruding part 73a is bent in this way, the protruding part 73a may be shorter as compared to a case where the protruding part 73a is bent in a direction of separating from the side face of the outer body part 71, if the lid plate 73 is to have the same rigidity in each case. Thus, weight of the chamber 131 may be reduced. A bend angle of the protruding part 73a is, for example, 25° or larger and 35° or smaller. Further, a length of the protruding part 73a is, for example, equal to or longer than 100 mm and equal to or shorter than 150 mm. The length is a length from a bent portion of the protruding part 73a to an end farthest from the bent portion, and is not the length between the side face of the outer body part 71 and the end. While FIG. 7 illustrates an example in which the bent portion is located beside the side face, the bent portion may be located on an edge of the side face.

Note that an in-plane direction of a flat area of the lid plate 73 excluding the protruding part 73a may be parallel to an in-plane direction of the bottom plate 51a, and the protruding part 73a may protrude outward from the side face of the outer body part 71 along the in-plane direction. Alternatively, the protruding part 73a may be bent to a side opposite to the side face of the outer body part 71. The length of the protruding part 73a is shortest in the case of being bent toward the side face of the outer body part 71, and becomes longer in the order of the case of being bent toward the side face of the outer body part 71, the case of being bent toward the side opposite to the side face of the outer body part 71, and the case of protruding along the in-plane direction.

When the protruding part 73a is provided, rigidity of the lid plate 73 increases as compared to a case where the protruding part 73a is not provided. Therefore, even when the inner housing 50 is to be deformed, the lid plate 73 can suppress deformation of the inner housing 50, and deformation of the lid plate 73 caused by the deformation of the inner housing 50 can also be suppressed. Further, since the deformation of the lid plate 73 is suppressed, the plate thickness of the lid plate 73 including the protruding part 73a can be reduced. Thus, even when the protruding part 73a is provided, the weight of the chamber 131 may be reduced, and the chamber 131 may be easier to handle.

As illustrated in FIG. 6, the front plate 75 is disposed at the opening 50a on one end side of the inner housing 50 and a peripheral edge portion of the opening 50a, and an opening on one end side of the outer housing 70 and a peripheral edge portion of the opening, in the longitudinal direction of the inner housing 50 and the outer body part 71. The front plate 75 is provided with an opening 75a. The opening 75a has substantially the same size and shape as the opening 50a of the inner housing 50, and overlaps the opening 50a when the front plate 75 is attached to one end side of the inner housing 50 and one end side of the outer body part 71. An unillustrated output side holder that holds the output coupling mirror 147 is attached to the front plate 75. The output side holder is attached to the front plate 75 such that the output coupling mirror 147 faces the opening 50a. In the present embodiment, the window 139b is not provided.

The rear plate 77 is disposed at an opening 50b on the other end side of the inner housing 50 and a peripheral edge portion of the opening 50b and an opening on the other end side of the outer housing 70 and a peripheral edge portion of the opening in the longitudinal direction of the inner housing 50 and the outer body part 71. The rear plate 77 is provided with an opening 77a illustrated in FIG. 9 to be described later. The opening 77a will be described later.

Since the partition wall 80 is provided in the outer housing 70, the strength of the outer housing 70 may be lower than the strength of the inner housing 50. Therefore, the plate thicknesses of the outer body part 71, the lid plate 73, the front plate 75, and the rear plate 77 may be smaller than the plate thickness of the inner housing 50. When the respective plate thicknesses are small, the weight of the chamber 131 is reduced as compared to a case where the respective plate thicknesses are the same as or larger than the plate thickness of the inner housing 50. The respective plate thicknesses of the outer body part 71, the lid plate 73, the front plate 75, and the rear plate 77 are, for example, equal to or larger than 1 mm and equal to or smaller than 3 mm. Examples of a material of the outer body part 71, the lid plate 73, the front plate 75, and the rear plate 77 include stainless steel and aluminum, as in the case of the inner housing 50.

As illustrated in FIG. 7 and FIG. 8, a plurality of partition walls 80 are provided, and each of the partition walls 80 is a support member that supports the inner housing 50, the outer body part 71, and the lid plate 73 excluding the protruding part 73a. The partition wall 80 is fixed to the outer peripheral surface of the inner housing 50 and the inner peripheral surface of the outer housing 70 by brazing. The partition wall 80 is brazed at each of the entire contacting portion with the outer peripheral surface of the inner housing 50 and the entire contacting portion with the inner peripheral surface of the outer housing 70. The inner peripheral surface of the outer housing 70 is the inner peripheral surface of the outer body part 71 and a back surface of the lid plate 73 excluding the protruding part 73a.

The respective partition walls 80 are disposed in parallel at predetermined intervals in the longitudinal direction of the inner housing 50 in a state where the in-plane direction of the partition wall 80 is disposed along a direction substantially perpendicular to the longitudinal direction of the inner housing 50. Accordingly, a surface of a certain partition wall 80 among the partition walls 80 faces a back surface of the partition wall 80 adjacent to the partition wall 80, and the adjacent partition wall 80 is disposed with a gap. The partition wall 80 is a wall that partitions a gap between the inner housing 50 and the outer body part 71 in a direction orthogonal to the longitudinal direction of the inner housing 50, and also partitions the gap in front and rear in the longitudinal direction of the inner housing 50. In addition, a gap is provided between the front plate 75 and the partition wall 80 adjacent to the front plate 75 and also between the rear plate 77 and the partition wall 80 adjacent to the rear plate 77. While FIG. 8 illustrates an example in which 11 partition walls 80 are disposed, at least one partition wall 80 may be disposed.

FIG. 9 is a diagram illustrating a positional relationship between the fin 57 and the partition wall 80. As illustrated in FIG. 9, the plurality of fins 57 are disposed on the inner peripheral surface of the inner housing 50. The respective fins 57 are, similarly to the partition walls 80, disposed in parallel at predetermined intervals in the longitudinal direction of the inner housing 50 in a state where the in-plane direction of the fin 57 is disposed along the direction substantially perpendicular to the longitudinal direction of the inner housing 50. In addition, the partition walls 80 and the fins 57 are alternately disposed along the longitudinal direction of the inner housing 50. The fins 57 are preferably disposed generally in the middle of the adjacent partition walls 80 in the longitudinal direction of the inner housing 50. Accordingly, a length between the adjacent partition walls 80 is approximately the same as a length between the adjacent fins 57. Note that, when the lengths between them are the same, the fins 57 may not be disposed substantially in the middle of the adjacent partition walls 80. While FIG. 9 illustrates an example in which the plurality of fins 57 are disposed, one fin 57 may or may not be disposed. Further, the fins 57 may be disposed along a circumferential direction of the inner housing 50. In this case, the adjacent fins 57 may be disposed apart from each other or may be disposed in contact with each other. Note that the rear plate 77 is provided with the opening 77a. The opening 77a has substantially the same size and shape as the opening 50b not illustrated in FIG. 9 of the inner housing 50, and overlaps the opening 50b when the rear plate 77 is attached to the other end side of the inner housing 50 and the other end side of the outer body part 71. To the rear plate 77, the housing 145a of the line narrowing module 145 is attached. The housing 145a is attached to the rear plate 77 such that the prism 145b faces the opening 50b of the inner housing 50. In the present embodiment, the window 139a is not provided. The laser beam comes and goes between the internal space of the inner housing 50 and the prism 145b not illustrated in FIG. 9 through the opening 77a.

The chamber 131 of the present embodiment includes a cooling passage 91 provided on an outer side of a wall surface of the chamber 131 in contact with the internal space of the chamber 131 for generating laser beam. The cooling passage 91 is configured to make a cooling medium, to be described later, that cools the chamber 131 flow. The cooling passage 91 of the present embodiment is provided between the inner housing 50 and the outer housing 70. As described above, since the gap is divided by the partition wall 80 between the inner housing 50 and the outer housing 70, the cooling passage 91 is the gap. The cooling passage 91 is provided so as to be in contact with area of 50% or more of an outer surface of the inner housing 50.

Through such a cooling passage 91, the cooling medium that cools the inner housing 50 when the laser beam is generated from the laser gas in the internal space, in the actual operation of the gas laser apparatus 100 after baking, flows. Examples of the cooling medium include, for example, a liquid such as water and oil, and a gas such as water vapor.

As illustrated in FIG. 7, FIG. 8, and FIG. 9, the chamber 131 further includes a passage 80a which is provided on the same position as the partition wall 80 in the longitudinal direction of the inner housing 50, and through which the cooling medium flows from one cooling passage 91 of the adjacent cooling passages 91 via the partition wall 80 to the other cooling passage 91 adjacent to the one cooling passage 91. An example is illustrated in which the passage 80a of the present embodiment is an opening provided in the partition wall 80. The passage 80a is part of the cooling passage 91. Between the front plate 75 and the rear plate 77, the cooling medium flows from the cooling passage 91 on the side of the front plate 75 through the passage 80a to the cooling passage 91 on the side of the rear plate 77 adjacent to the cooling passage 91.

When viewed along the longitudinal direction of the inner housing 50, the passage 80a of one partition wall 80 of the adjacent partition walls 80 is provided on a position that does not overlap the passage 80a of the other partition wall 80. In addition, FIG. 7, FIG. 8, and FIG. 9, illustrate an example in which, when viewed along the longitudinal direction of the inner housing 50, the passage 80a of one partition wall 80 is provided on the opposite side of the passage 80a of the other partition wall 80 with reference to a non-circulation area where the cooling medium does not flow in the cooling passage 91. The non-circulation region is an area between the respective protrusions 53 of the curved plates 51b and 51c in the in-plane direction of the bottom plate 51a. When viewed along the longitudinal direction of the inner housing 50, for example, the cooling medium flows clockwise in the circumferential direction of the inner housing 50 through the cooling passage 91 on the side of the front plate 75, and flows counterclockwise in the circumferential direction through the cooling passage 91 on the side of the rear plate 77 adjacent to the cooling passage 91. Therefore, the cooling medium flows in opposite directions in the adjacent cooling passages 91. The flow of the cooling medium in the respective cooling passages 91 is illustrated by dashed arrows in FIG. 8. In FIG. 8, for the sake of clarity, one of each flow is illustrated. In the cooling passage 91, as described above, the partition wall 80 is brazed at each of the entire contacting portion with the outer peripheral surface of the inner housing 50 and the entire contacting portion with the inner peripheral surface of the outer housing 70. Therefore, leakage of the cooling medium from the contacting portion is suppressed, and the cooling medium flows through the passage 80a from one cooling passage 91 of the adjacent cooling passages 91 to the other cooling passage 91. In the actual operation of the gas laser apparatus 100 after baking, the cooling medium flows through the cooling passage 91 and the passage 80a. As a result, the cooling medium comes into contact with the inner housing 50 and directly cools the inner housing 50. By cooling, a temperature rise of the inner housing 50 caused by the laser beam in the internal space of the inner housing 50 can be suppressed, and the deformation of the inner housing 50 due to the temperature rise can be suppressed.

In the cooling passage 91, a heating medium that heats the internal space flows during baking of the chamber 131 before the gas laser apparatus 100 is actually operated. Therefore, the cooling passage 91 is shared by the heating medium and the cooling medium. The heating medium is preferably the same material as the cooling medium, but may be a material different from the cooling medium. The heating medium flows through the cooling passage 91 and the passage 80a in the same manner as the flow of the cooling medium described above.

FIG. 10 is a diagram illustrating the disposition of the chamber 131 at the time of baking in the present embodiment. In FIG. 10, the chamber 131 is simply illustrated. A pipe 93a is connected to an inlet 75d provided on the front plate 75 of the chamber 131, and a pipe 93b is connected to an outlet 77d provided on the rear plate 77. The pipe 93a and the pipe 93b are connected to a heat exchanger 95 disposed in the external space of the outer housing 70, that is, the chamber 131. The heat exchanger 95 supplies the heating medium to the cooling passage 91 between the inner housing 50 and the outer body part 71 through the pipe 93a by an unillustrated pump of the heat exchanger 95, and heats the internal space of the inner housing 50 by the heating medium. The heat exchanger 95 circulates the heating medium in the order of the heat exchanger 95, the pipe 93a, the cooling passage 91, the passage 80a, the pipe 93b, and the heat exchanger 95. Note that the heat exchanger 95 may circulate the heating medium in the opposite manner to the above. The cooling passage 91 is the cooling passage 91 between the front plate 75 and the partition wall 80 adjacent to the front plate 75, each cooling passage 91 between the adjacent partition walls 80, and also the cooling passage 91 between the rear plate 77 and the partition wall 80 adjacent to the rear plate 77. Each cooling passage 91 between the adjacent partition walls 80 is surrounded by the partition walls 80, the curved plates 51b and 51c, the protrusions 53, the outer body part 71, and the lid plate 73.

A temperature of the internal space of the inner housing 50 is measured by an unillustrated temperature sensor. The heat exchanger 95 adjusts a temperature of the heating medium based on the measured temperature of the internal space. A set temperature of the heating medium is, for example, 150° C. or higher.

One pipe 303a connected to the vacuum pump 303 passes through the outer housing 70 and communicates with the internal space of the inner housing 50. The other pipe 303b connected to the vacuum pump 303 communicates with the outside. The vacuum pump 303 sucks the gas impurities in the internal space heated by the heating medium through the pipe 303a, and exhausts the gas to the outside of the chamber 131 through the pipe 303b. The impurities include desorbed moisture.

Next, a configuration of making the cooling medium flow through the cooling passage 91 will be described. The configuration is used when the laser beam is generated from the laser gas in the internal space in the actual operation of the gas laser apparatus 100 after baking. When the cooling medium flows through the cooling passage 91, the vacuum pump 303 is detached, and an unillustrated temperature controller is attached instead of the heat exchanger 95. The temperature controller is disposed inside the housing 110 of the gas laser apparatus 100. The temperature controller is a chiller that supplies the cooling medium to the cooling passage 91 between the inner housing 50 and the outer body part 71 through the pipe 93a by an unillustrated pump of the temperature controller, and cools the inner housing 50 by the cooling medium. The cooling medium is circulated in the same way as the heating medium. The temperature controller is electrically connected to the laser processor 190, and the laser processor 190 outputs a signal indicating the temperature of the cooling medium to the temperature controller based on a signal from the temperature sensor. The temperature controller adjusts the temperature of the cooling medium based on the signal from the laser processor 190. A set temperature of the cooling medium is, for example, 20° C. or higher and 70° C. or lower, and a temperature range of the cooling medium flowing through the cooling passage 91 is preferably +3° C. of the set temperature.

### 3.2 Method of Baking Chamber

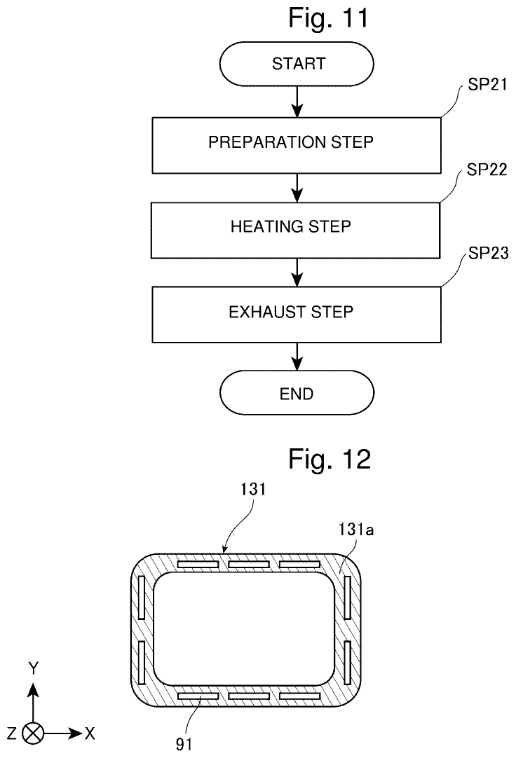

FIG. 11 is a diagram illustrating an example of a flowchart of the baking method in the present embodiment. The baking method of the present embodiment includes a preparation step SP21, a heating step SP22, and an exhaust step SP23.

### (Preparation Step SP21)

In this step, the chamber 131 is loaded in the housing 110 of the gas laser apparatus 100, and is specifically installed inside the housing 110. In addition, to the chamber 131, the pipes 93a, 93b, 303a, and 303b are connected. That is, the heat exchanger 95 and the vacuum pump 303 are connected to the chamber 131. Then, the heating medium is heated to 150° C. or higher by the heat exchanger 95. Once such preparation is completed, the flow proceeds to the heating step SP22.

### (Heating Step SP22)

In this step, the heating medium is made to flow from the heat exchanger 95 to the cooling passage 91 through the pipe 93a, and the heat of the heating medium is transmitted from the inner housing 50 to the internal space of the inner housing 50 and from the inner housing 50 to the internal space of the inner housing 50 via the fins 57. Thus, the temperature of the internal space of the inner housing 50 is raised to 150° C. or higher, and the internal space of the inner housing 50 is heated. By heating, the moisture adsorbed in the internal components of the chamber 131 is desorbed from the internal components. The heating medium returns from the cooling passage 91 to the heat exchanger 95 through the pipe 93b, is again heated to 150° C. or higher in the heat exchanger 95, and flows to the cooling passage 91 through the pipe 93a. Therefore, the heating medium is circulated through the heat exchanger 95, the pipe 93a, the cooling passage 91, the pipe 93b, and the heat exchanger 95. When the temperature of the internal space becomes 150° C. or higher, the flow proceeds to the exhaust step SP23.

### (Exhaust Step SP23)

In this step, similarly to the exhaust step SP13, the gas impurities including the desorbed moisture are exhausted from the internal space of the heated chamber 131 to the external space of the chamber 131 by the vacuum pump 303.

Note that at least a part of this step may overlap the heating step SP22 and may be performed simultaneously with the heating step SP22. In addition, this step may end before the heating step SP22, simultaneously with the heating step SP22, or after the heating step SP22. It takes eight hours or longer from start of the heating step SP22 to the end of either of the heating step SP22 and the exhaust step SP23 which ends later.

In this step, when the gas is exhausted, since the chamber 131 is already installed inside the housing 110 of the gas laser apparatus 100 as described in the preparation step SP21, the flow ends. Then, the gas laser apparatus 100 stands by for the actual operation.

### 3.3 Effect

The baking method of the present embodiment includes the heating step SP22 of making the heating medium flow through the cooling passage 91 and heating the internal space via the wall surface prior to generating light in the internal space of the chamber 131, and the exhaust step SP23 of exhausting the gas in the heated internal space to the external space of the chamber 131.

In this baking method, the heating medium flows through the cooling passage 91 so that the internal space is heated. The moisture adsorbed in the internal components of the chamber 131 such as the electrode 133a disposed in the internal space of the chamber 131 is desorbed from the internal components by the heating, and the moisture is exhausted to the outside of the chamber 131 together with the gas in the internal space. In such a baking method, as compared to a case where the mantle heater 301 is wound around the chamber 131 to heat the internal space of the chamber 131, a gap is not generated between the chamber 131 and the mantle heater 301. Therefore, the temperature of the internal space can be raised in a short time, and the baking period can be shortened.

Further, in the baking method of the present embodiment, the chamber 131 includes the inner housing 50 and the outer housing 70 which surrounds the inner housing 50 from the lateral side of a light traveling direction. The cooling passage 91 is provided between the inner housing 50 and the outer housing 70. In this baking method, since the cooling passage 91 is provided between the inner housing 50 and the outer housing 70, need of installing the chamber 131 in the facility for baking may be eliminated.

In the baking method of the present embodiment, the chamber 131 further includes the partition wall 80 disposed between the inner housing 50 and the outer housing 70 and fixed to the inner housing 50 and the outer housing 70.

In the chamber 131, at the time heating the internal space of the inner housing 50 by the heating medium, when the temperature of the internal space rises, a temperature distribution in the internal space may be biased. In addition, a pressure in the internal space may decrease due to exhaust of the gas from the internal space of the inner housing 50. The inner housing 50 is to be deformed by thermal expansion of the inner housing 50 caused by the temperature rise, a thermal expansion difference in the internal space of the inner housing 50 caused by bias of the temperature distribution, and pressure decrease. However, in this configuration, the deformation of the inner housing 50 can be suppressed by the partition wall 80 fixed to the outer peripheral surface of the inner housing 50 and the outer housing 70 to which the partition wall 80 is fixed. For example, even when the inner housing 50 is to be deformed so as to expand by the thermal expansion, expansion of the inner housing 50 can be suppressed by the partition wall 80 and the outer housing 70. Further, even when the inner housing 50 is to be deformed so as to shrink by the pressure decrease, shrinkage of the inner housing 50 can be suppressed by the partition wall 80 and the outer housing 70. Since the deformation of the inner housing 50 is suppressed in this way, a change of the traveling direction of the laser beam output from the inner housing 50 after the baking is completed from a previously assumed traveling direction can be suppressed. By suppressing the change, a change of the traveling direction of the light output from the gas laser apparatus 100 toward the exposure apparatus 200 from a previously assumed traveling direction can be suppressed. Therefore, decline of reliability of the gas laser apparatus 100 can be suppressed.

In addition, since the partition wall 80 and the outer housing 70 suppress the deformation of the inner housing 50, the plate thickness of the inner housing 50 can be reduced as compared to a state where the partition wall 80 and the outer housing 70 are not provided. Accordingly, even when the partition wall 80 and the outer housing 70 are disposed, the weight of the chamber 131 may be reduced, and the chamber 131 may be easier to handle. Further, in order to suppress the deformation of the inner housing 50 in the state where the partition wall 80 and the outer housing 70 are not provided, it is necessary to increase the rigidity of the inner housing 50. In the baking method of the present embodiment, since the partition wall 80 and the outer housing 70 suppress the deformation of the inner housing 50, it is possible to suppress the plate thickness of the inner housing 50 from increasing. In addition, in the baking method of the present embodiment, the rigidity of the chamber 131 can be increased by the partition wall 80 and the outer housing 70.

Further, in the baking method of the present embodiment, a plurality of partition walls 80 are provided, and the respective partition walls 80 are disposed in parallel at intervals in the light traveling direction. In this case, the deformation of the inner housing 50 can be suppressed and the rigidity of the chamber 131 can be increased as compared to a case where there is only one partition wall 80.

In addition, in the baking method of the present embodiment, the chamber 131 further includes the passage 80a which is provided on the same position as the partition wall 80 in the light traveling direction, and through which the heating medium flows from one cooling passage 91 of the adjacent cooling passages 91 to the other cooling passage 91. In order for the heating medium to flow through the respective cooling passages 91 when the passage 80a is not provided, the pipes need to be connected to the respective cooling passages 91. However, since the passage 80a is provided, the need of connecting pipes to the respective cooling passages 91 is eliminated, and the weight of the chamber 131 may be reduced. Further, since the inlet 75d is provided on the front plate 75 and the outlet 77d is provided on the rear plate 77, the heating medium can be circulated through the cooling passage 91 by flowing through the respective cooling passages 91.

Note that the passage 80a may not be provided in each partition wall 80, a pipe may be connected to each cooling passage 91, and the heating medium may flow to each cooling passage 91. When the heating medium is circulated as described above, in a process in which the heating medium flows from an upstream side to a downstream side, the temperature of the heating medium may decrease, and the internal space of the inner housing 50 may not be heated to be higher than an assumed temperature. However, when the heating medium flows to each cooling passage 91, a change in the temperature of the heating medium can be suppressed and the internal space of the inner housing 50 can be heated as compared to a case where the heating medium is circulated as described above.

The passage 80a may not be disposed in all of the partition walls 80. For example, when the passage 80a is not provided in the fifth partition wall 80 from the side of the front plate 75, the first to fifth cooling passages 91 from the side of the front plate 75 become one flow path, the sixth to twelfth cooling passages 91 from the side of the front plate 75 become the cooling passage 91 different from the cooling passage 91. In this case, a pipe may be connected to each of the cooling passages 91, and the heating medium may flow to each of the cooling passages 91. Further, a plurality of passages 80a may be provided in one partition wall 80.

Further, in the baking method of the present embodiment, when viewed along the light traveling direction, the passage 80a in one partition wall 80 of the adjacent partition walls 80 is provided on a position that does not overlap the passage 80a provided in the other partition wall 80. As a result, the heating medium can flow in opposite directions in the adjacent cooling passages 91.

In the baking method of the present embodiment, the heating medium is the same material as the cooling medium. When the heating medium is a material different from the cooling medium and the cooling medium flows to the cooling passage 91 after the heating medium for example, the heating medium may remain in the cooling passage 91, and the chamber 131 may be hardly cooled due to the heating medium remaining in the cooling passage 91 even when the cooling medium flows to the cooling passage 91. Therefore, the cooling passage 91 may be cleaned in order to remove the heating medium from the cooling passage 91. However, in this configuration, since the heating medium is the same material as the cooling medium, even when the heating medium remains, it is not necessary to remove the heating medium, and the need of cleaning the cooling passage 91 may be eliminated.

In addition, in the baking method of the present embodiment, the heating medium is heated by the heat exchanger 95 disposed in the external space of the chamber 131. According to this configuration, it is possible to suppress enlargement of the chamber 131 as compared to a case where the heat exchanger 95 is disposed inside the chamber 131. Note that the heat exchanger 95 may not be disposed in the external space of the chamber 131.

In the baking method of the present embodiment, the heating step SP22 and the exhaust step SP23 are performed with the chamber 131 being loaded in the housing 110 of the gas laser apparatus 100. According to this configuration, when the baking of the chamber 131 is completed, the laser beam can be output from the gas laser apparatus 100 without moving the chamber 131.

Further, in the baking method of the present embodiment, at least a part of the exhaust step SP23 is performed simultaneously with the heating step SP22. According to this configuration, the baking period can be shortened as compared to a case where the exhaust step SP23 is performed after the end of the heating step SP22.

In addition, in the baking method of the present embodiment, the fin 57 is disposed on the inner peripheral surface of the inner housing 50, and the heat of the heating medium is discharged to the internal space of the inner housing 50 via the fin 57. In a case where the fin 57 is disposed, a heat discharge amount can be increased and the temperature of the internal space of the inner housing 50 can be raised more easily as compared to a case where the fin 57 is not disposed.

In the baking method of the present embodiment, the plurality of fins 57 are provided. In this case, the heat discharge amount is increased as compared to a case where there is only one fin 57. As the heat discharge amount increases, the temperature of the internal space of the chamber 131 can be increased in a shorter time, and the baking period can be further shortened.

Further, in the baking method of the present embodiment, the partition walls 80 and the fins 57 are alternately disposed along the light traveling direction. The rigidity of the inner housing 50 between adjacent partition walls 80 is lower than the rigidity of the inner housing 50 at parts where the partition walls 80 are positioned. When the partition walls 80 and the fins 57 are alternately disposed as described above, the rigidity of the inner housing 50 between the adjacent partition walls 80 is increased as compared to a case where the partition walls 80 are disposed adjacently to the fins 57 via the inner housing 50. Note that the fins 57 may be disposed adjacently to the partition walls 80 via the inner housing 50.

In addition, in the baking method of the present embodiment, the fins 57 are disposed in the middle of the adjacent partition walls 80. In this case, a change in strength distribution of the inner housing 50 in the longitudinal direction of the inner housing 50 can be suppressed, and the deformation of the inner housing 50 can be suppressed, as compared to a case where the fins 57 are disposed to be shifted to either one of the partition walls 80 between the adjacent partition walls 80. Note that the length between the adjacent partition walls 80 may be different from the length between the adjacent fins 57.

In the chamber 131 of the present embodiment, the heat exchanger 151 is disposed in the internal space of the inner housing 50. The heat exchanger 151 may heat the heating medium flowing through the heat exchanger 151. Then, in the heating step SP22, the internal space may be heated further by making the heating medium flow further through the heat exchanger 151 and heating the heating medium in the heat exchanger 151. According to this configuration, the temperature of the internal space can be raised in a shorter time, and the baking period can be further shortened. Note that, in the heating step SP22, the heating medium may not be made to flow through the heat exchanger 151, and the internal space may not be further heated.

FIG. 12 is a sectional view of the chamber 131 in a modification. In FIG. 12, the configuration of the chamber 131 is briefly described, and the internal components and the electric insulating part 135 in the internal space of the chamber 131 are not illustrated. The chamber 131 of the present modification includes a wall part 131a. The wall part 131a is provided with a wall surface in contact with the internal space of the chamber 131. The cooling passage 91 of the present modification may be provided inside the wall part 131a. An inlet and an outlet that are not illustrated of the cooling passage 91 are provided in front of the chamber 131. The cooling passage 91 extends from a front side toward a back side along the laser beam traveling direction, that is, along the Z direction between the inlet and the outlet, is folded back toward the front side on the back side, and extends toward the front side along the Z direction. Further, the cooling passage 91 is folded back toward the back side on the front side and extends toward the back side along the Z direction. In such a cooling passage 91, the cooling medium or the heating medium flows in opposite directions in the adjacent cooling passages 91.

In the chamber 131 of the present embodiment, the passage 80a is an opening, but it is not limited thereto. For example, a part of the partition wall 80 may be disposed away from at least one of the inner housing 50 and the outer housing 70, and the passage 80a may be a gap between the part and at least one of the inner housing 50 and the outer housing 70. Examples of such a passage 80a include, for example, a gap for which a part of the partition wall 80 is disposed away from the other end side of the curved plate 51b and the protrusion 53 on the side of the curved plate 51b, and which is formed between the other end side of the curved plate 51b, the protrusion 53, the partition wall 80, and the lid plate 73. The gap may be provided on the side of the curved plate 51c. Alternatively, the passage 80a may be formed by a notch provided in the partition wall 80 and the lid plate 73 that closes an opening in the notch.

The outer housing 70 may surround at least a part of the inner housing 50. The outer housing 70 may surround the inner housing 50 at least from the lateral side of the laser beam traveling direction. The outer body part 71 may be longer or shorter than the inner housing 50.

The fin 57 may be fixed to the inner peripheral surface of the inner housing 50, and the partition wall 80 may be fixed to the outer peripheral surface of the inner housing 50 and the inner peripheral surface of the outer housing 70 by welding. The fin 57 may be disposed on the outer peripheral surface of the outer housing 70.

A member disposed between the inner housing 50 and the outer housing 70 and fixed to each of them need not be limited to the partition wall 80. The member may support the inner housing 50, the outer body part 71, and the lid plate 73 excluding the protruding part 73a, and examples of the member include a rod-shaped member that supports the inner housing 50 and the outer body part 71 of the outer housing 70. A plurality of rod-shaped members may be provided, and may extend radially from the outer peripheral surface of the inner housing 50 toward the inner peripheral surface of the outer body part 71 and the back surface of the lid plate 73 excluding the protruding part 73a with respect to the central axis of the inner housing 50 like spokes. In addition, the partition walls 80 may be disposed along the circumferential direction of the inner housing 50. In this case, the adjacent partition walls 80 may be disposed apart from each other or may be disposed in contact with each other.

A temperature sensor may be provided in the cooling passage 91 and the pipes 93a and 93b. The temperature sensor measures the temperature of the heating medium flowing therethrough. The heat exchanger 95 may adjust the temperature of the heating medium based on the measured temperature of the heating medium. While the description has been made using the heating medium here, the same applies to the cooling medium.

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that embodiments of the present disclosure would be appropriately combined.

The terms used throughout the present specification and the claims should be interpreted as non-limiting terms unless clearly described. For example, terms such as “comprise”, “include”, “have”, and “contain” should not be interpreted to be exclusive of other structural elements. Further, indefinite articles “a/an” should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A method of baking a chamber of a gas laser apparatus provided with a cooling passage configured to make a cooling medium that cools the chamber flow on an outer side of a wall surface in contact with an internal space of the chamber for generating light in the internal space, the method comprising:
a heating step of heating the internal space via the wall surface by making a heating medium flow through the cooling passage before generating the light in the internal space; and
an exhaust step of exhausting a gas in the heated internal space to an external space of the chamber.

2. The method of baking a chamber of a gas laser apparatus according to claim 1, wherein
the chamber includes
an inner housing including the wall surface, the internal space, and a passage opening through which the light passes in the internal space, and
an outer housing surrounding at least a part of the inner housing from a lateral side of a traveling direction of the light, and
the cooling passage is provided between the inner housing and the outer housing.

3. The method of baking a chamber of a gas laser apparatus according to claim 2, wherein
the inner housing and the outer housing are made of stainless steel.

4. The method of baking a chamber of a gas laser apparatus according to claim 2, wherein
the cooling passage is provided so as to be in contact with area of 50% or more of an outer surface of the inner housing.

5. The method of baking a chamber of a gas laser apparatus according to claim 2, wherein
the chamber further includes a partition wall disposed between the inner housing and the outer housing and fixed to the inner housing and the outer housing.

6. The method of baking a chamber of a gas laser apparatus according to claim 5, wherein
the partition wall comprises a plurality of partition walls, and
the respective partition walls are disposed in parallel at intervals in the traveling direction of the light.

7. The method of baking a chamber of a gas laser apparatus according to claim 5, wherein
a gap segmented by the partition wall between the inner housing and the outer housing is the cooling passage.

8. The method of baking a chamber of a gas laser apparatus according to claim 7, wherein
the chamber further includes a passage which is provided on a same position as the partition wall in the traveling direction of the light, and through which the heating medium flows from one cooling passage of adjacent cooling passages to another cooling passage.

9. The method of baking a chamber of a gas laser apparatus according to claim 8, wherein
the partition wall comprises a plurality of partition walls,
the respective partition walls are disposed in parallel at intervals in the traveling direction of the light, and
when viewed along the traveling direction of the light, the passage provided on a same position in the traveling direction of the light as one partition wall of adjacent partition walls is provided on a position that does not overlap with the passage provided on the same position in the traveling direction of the light as another partition wall adjacent to the one partition wall.

10. The method of baking a chamber of a gas laser apparatus according to claim 1, wherein
the heating medium is a same material as the cooling medium.

11. The method of baking a chamber of a gas laser apparatus according to claim 1, wherein
the heating medium is oil or water.

12. The method of baking a chamber of a gas laser apparatus according to claim 1, wherein
a temperature of the heating medium is 150° C. or higher.

13. The method of baking a chamber of a gas laser apparatus according to claim 1, wherein
the heating medium is heated by a heat exchanger disposed in the external space of the chamber.

14. The method of baking a chamber of a gas laser apparatus according to claim 1, wherein
the heating step and the exhaust step are performed in a state where the chamber is loaded in a housing of the gas laser apparatus.

15. The method of baking a chamber of a gas laser apparatus according to claim 1, wherein
at least a part of the exhaust step is performed simultaneously with the heating step.

16. The method of baking a chamber of a gas laser apparatus according to claim 1, wherein
it takes eight hours or longer from start of the heating step to end of either of the heating step and the exhaust step which ends later.

17. The method of baking a chamber of a gas laser apparatus according to claim 1, wherein
in the heating step, the heating medium is made to flow further through a heat exchanger provided in the internal space to heat the internal space further.

18. The method of baking a chamber of a gas laser apparatus according to claim 1, wherein
the chamber includes a partition wall including the wall surface, and
the cooling passage is provided inside the partition wall.

19. An electronic device manufacturing method comprising:
generating a laser beam by a gas laser apparatus including a chamber baked by a method of baking a chamber of a gas laser apparatus provided with a cooling passage configured to make a cooling medium that cools the chamber flow on an outer side of a wall surface in contact with an internal space of the chamber for generating light in the internal space, the method including
a heating step of heating the internal space via the wall surface by making a heating medium flow through the cooling passage before generating the light in the internal space, and
an exhaust step of exhausting a gas in the heated internal space to an external space of the chamber;
outputting the laser beam to an exposure apparatus; and
exposing a photosensitive substrate to the laser beam within the exposure apparatus to manufacture an electronic device.
